(19) United States
(12) Patent Application Publication
(10) Pub. No.: US 2019/0246079 A1
(43) Pub. Date: Aug. 8, 2019

(54) PROJECTION DISPLAY UNIT

(71) Applicant: SONY CORPORATION, Tokyo (JP)

(72) Inventor: Takahiro MOCHIZUKI, Kanagawa (JP)

(73) Assignee: SONY CORPORATION, Tokyo (JP)

(21) Appl. No.: 16/318,454

(22) PCT Filed: Jun. 9, 2017
(86) PCT No.: PCT/JP2017/021438

§ 371 Date: Jan. 17, 2019

(30) Foreign Application Priority Data
Jul. 26, 2016 (JP) 2016-146560

(51) Int. Cl. H04N 9/31; G03B 33/12; G03B 21/20; G02B 27/42

(52) U.S. Cl. CPC H04N 9/312; G03B 33/12; G03B 21/2033; H04N 9/3164; G02B 27/425; H04N 9/3161; G03B 21/2013

(57) ABSTRACT

A projection display unit that is provided with a light source; a diffraction device that light from the light source enters; a spatial light modulation device that at least a portion of zero-order light, and first-order diffracted light of the diffraction device enter; and a projection optical system that light passing through the spatial light modulation device enters.

### TECHNICAL FIELD

The technology relates to a projection display unit having a diffraction device and a spatial light modulation device.

### BACKGROUND ART

To date, a projector (a projection display unit) having a diffraction device and a spatial light modulation device has been reported (for example, PTLs 1 and 2). From the diffraction device, first-order diffracted light is extracted as diffracted light to be utilized.

### CITATION LIST

### Patent Literature

PTL 1: Japanese Unexamined Patent Application Publication No. 2008-292725
PTL 2: Japanese Unexamined Patent Application Publication No. 2008-89686

### SUMMARY OF THE INVENTION

In such a projector, diffractive efficiency of the first-order diffracted light is likely to deteriorate, which also causes deterioration in optical utilization efficiency.

It is therefore desirable to provide a projection display unit that improves the optical utilization efficiency.

A projection display unit according to an embodiment of the technology includes: a light source; a diffraction device that light from the light source enters; a spatial light modulation device that at least a portion of zero-order light, and first-order diffracted light of the diffraction device enter; and a projection optical system that light passing through the spatial light modulation device enters.

In the projection display unit according to the embodiment of the technology, at least a portion of the zero-order light enters the spatial light modulation device along with the first-order diffracted light. This eliminates the need for separation of the first-order diffracted light and the zero-order light, which makes it possible to provide the diffraction device with the high diffractive efficiency without taking account of a diffractive angle, etc. of the diffraction device, for example.

According to the projection display unit of the embodiment of the technology, at least a portion of the zero-order light enters the spatial light modulation device along with the first-order diffracted light, which allows the diffractive efficiency of the first-order diffracted light to be improved. This makes it possible to enhance the optical utilization efficiency. It is to be noted that the effects described here are not necessarily limitative, and the effects of the technology may be any of the effects that will be described herein.

### BRIEF DESCRIPTION OF DRAWINGS

FIG. 1 is a schematic view of an overall configuration of a projection display unit according to an embodiment of the technology.

FIG. 2 is a diagram illustrating light passing through a blue diffraction device illustrated in FIG. 1.

FIG. 3 is a diagram illustrating light entering a blue spatial light modulation device from the blue diffraction device illustrated in FIG. 1.

FIG. 4 is a schematic view of a configuration of a control section illustrated in FIG. 1 along with a configuration of an optical section.

FIG. 5 is a plan view of an example of an image incoming as an image signal illustrated in FIG. 4.

FIG. 6A is a graph of the diffractive efficiency with respect to diffractive angles of a diffraction device.

FIG. 6B is a graph of the diffractive efficiency with respect to gray scales of the diffraction device.

FIG. 7 is a schematic view of a configuration of a blue optical section of a projection display unit according to a modification example 1.

FIG. 8A is a plan view (1) illustrating effects of a lens illustrated in FIG. 7.

FIG. 8B is a plan view (2) illustrating the effects of the lens illustrated in FIG. 7.

FIG. 9 is a schematic view of a configuration of an optical section of a projection display unit according to a modification example 2.

FIG. 10 is a schematic view of a configuration of an optical section of a projection display unit according to a modification example 3.

FIG. 11 is a schematic view of a configuration of an optical section of a projection display unit according to a modification example 4.

FIG. 12 is a schematic view of a configuration of an optical section of a projection display unit according to a modification example 5.

### MODES FOR CARRYING OUT THE INVENTION

Hereinafter, embodiments of the technology are described in detail with reference to the drawings. It is to be noted that the description is given in the following order.

### 1. Embodiment

An example of having a transmissive diffraction device and a reflective spatial light modulation device

### 2. Modification Example 1

An example of having a lens at an optical path between a diffraction device and a spatial light modulation device

### 3. Modification Example 2

An example of having a transmissive diffraction device and a transmissive spatial light modulation device

### 4. Modification Example 3

An example of having a reflective diffraction device and a transmissive spatial light modulation device

### 5. Modification Example 4

An example of having a reflective diffraction device and a reflective spatial light modulation device

### 6. Modification Example 5

An example of having a white light source

### Embodiment

### (Configuration)

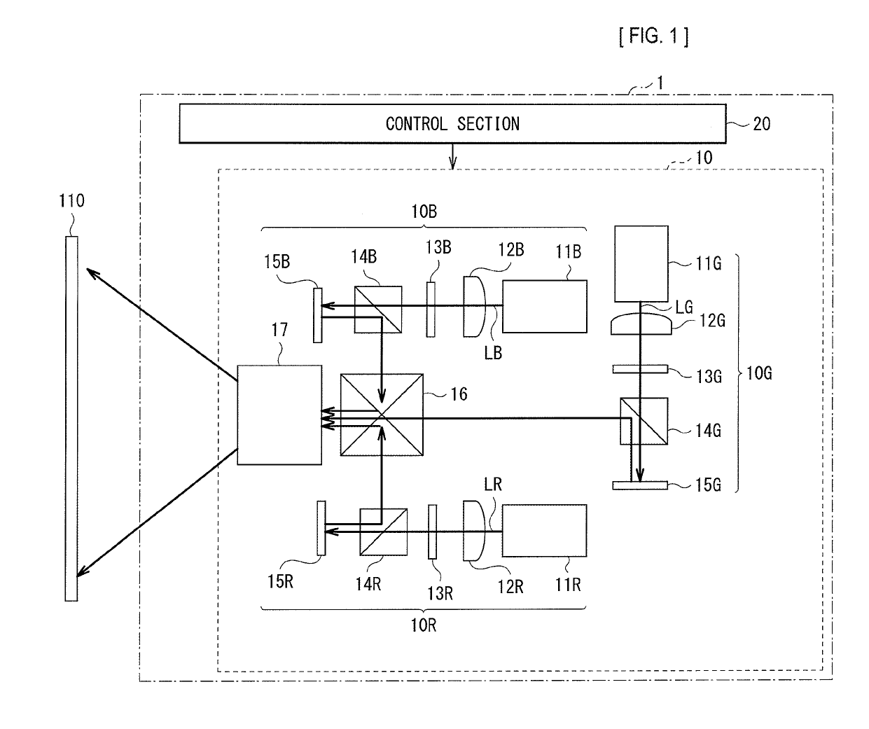

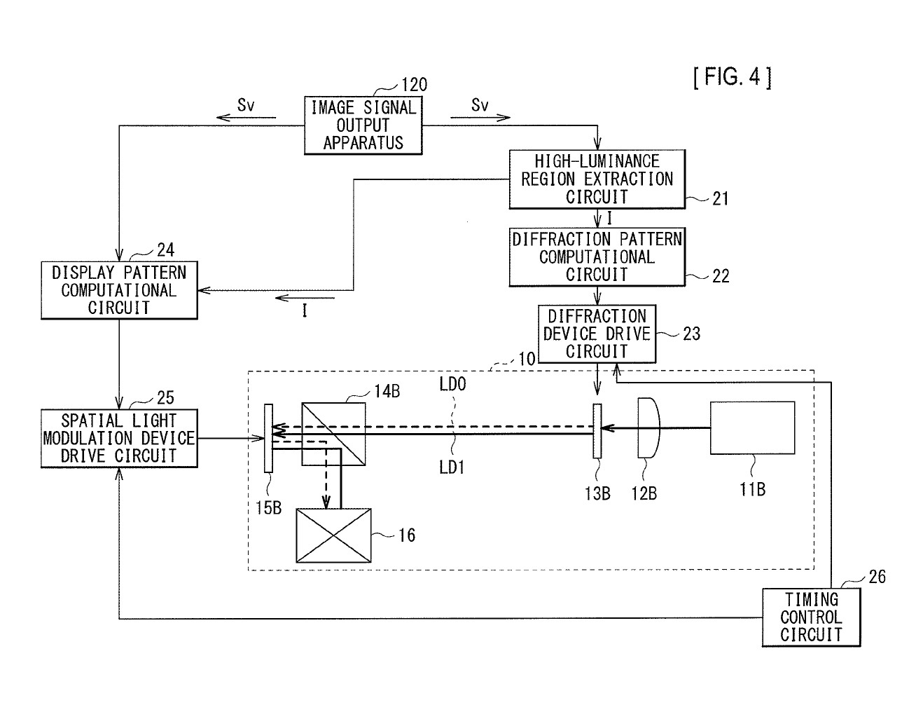

FIG. 1 is a schematic view of an overall configuration of a projection display unit (a projection display unit 1) according to an embodiment of the technology. The projection display unit 1 is, for example, a display unit that projects images on a screen. The projection display unit 1 is coupled to an external image signal output apparatus (for example, an image signal output apparatus 120 in FIG. 4 to be described later) including, for example, a computer such as a PC, or various image players, etc. through an I/F (interface), and carries out image projection on a screen on the basis of image signals incoming into the I/F. It is to be noted that a configuration of the projection display unit 1 to be described below is illustrative only, and the projection display unit of the technology is not limited to such a configuration.

The projection display unit 1 includes an optical section 10, and a control section 20 that controls operation of the optical section 10. The optical section 10 includes a red optical section 10R having a red light source 11R, a green optical section 10G having a green light source 11G, and a blue optical section 10B having a blue light source 11B, a color synthesizing device 16, and a projection optical system 17. In the red optical section 10R, a red shaping optical system 12R, a red diffraction device 13R, a red polarization split device 14R, and a red spatial light modulation device 15R are provided in order from a position close to the red light source 11R at an optical path of red light L_{R} emitted from the red light source 11R. In the green optical section 10G, a green shaping optical system 12G, a green diffraction device 13G, a green polarization split device 14G, and a green spatial light modulation device 15G are provided in order from a position close to the green light source 11G at an optical path of green light L_{G} emitted from the green light source 11G. In the blue optical section 10B, a blue shaping optical system 12B, a blue diffraction device 13B, a blue polarization split device 14B, and a blue spatial light modulation device 15B are provided in order from a position close to the blue light source 11B at an optical path of blue light L_{B} emitted from the blue light source 11B. Light (red light, green light, and blue light) emitted respectively from the red optical section 10R, the green optical section 10G, and the blue optical section 10B enters the color synthesizing device 16 to be guided from the color synthesizing device 16 to the projection optical system 17.

The red light source 11R, the green light source 11G, and the blue light source 11B are light sources that emit light of red wavelength band, green wavelength band, and blue wavelength band respectively, and include solid-state light sources, for example. The red light source 11R, the green light source 11G, and the blue light source 11B preferably generate highly coherent light, and include semiconductor lasers (LD), for example.

The red shaping optical system 12R, the green shaping optical system 12G, and the blue shaping optical system 12B include, for example, lens groups and polarization converter devices, etc. The lens groups are, for example, a beam expander, a fly-eye lens, etc., and the polarization converter devices are, for example, a wave plate and a polarizer, etc. The red shaping optical system 12R serves to convert a beam form of the red light L_{R} emitted from the red light source 11R into a desired form to irradiate the red diffraction device 13R with a light beam having a resulting form. Similarly, the green shaping optical system 12G converts the green light L_{G} emitted from the green light source 11G into a desired beam form to irradiate the green diffraction device 13G with a light beam having a resulting form, and the blue shaping optical system 12B converts a beam form of the blue light L_{B} emitted from the blue light source 11B into a desired beam form to irradiate the blue diffraction device 13B with a light beam having a resulting form. Along with such conversion of the beam forms, the red shaping optical system 12R, the green shaping optical system 12G, and the blue shaping optical system 12B undertake a role of improving the efficiency of phase modulation in the red diffraction device 13R, the green diffraction device 13G, and the blue diffraction device 13B by aligning polarization of the red light L_{R}, the green light L_{G}, and the blue light L_{B}, respectively.

The red diffraction device 13R, the green diffraction device 13G, and the blue diffraction device 13B include liquid crystal panels, for example. The red diffraction device 13R, the green diffraction device 13G, and the blue diffraction device 13B are, for example, transmissive diffraction devices, in which diffracted light of the light (the red light L_{R}, the green light L_{G}, and the blue light L_{B}) that enters from a rear surface side is extracted from a front surface side. In the red diffraction device 13R, the green diffraction device 13G, and the blue diffraction device 13B, illuminating light having predetermined intensity distribution that serves to respectively irradiate the red spatial light modulation device 15R, the green spatial light modulation device 15G, and the blue spatial light modulation device 15B therewith is generated depending on an incoming image signal (an image signal S_{V} in FIG. 4 to be described later).

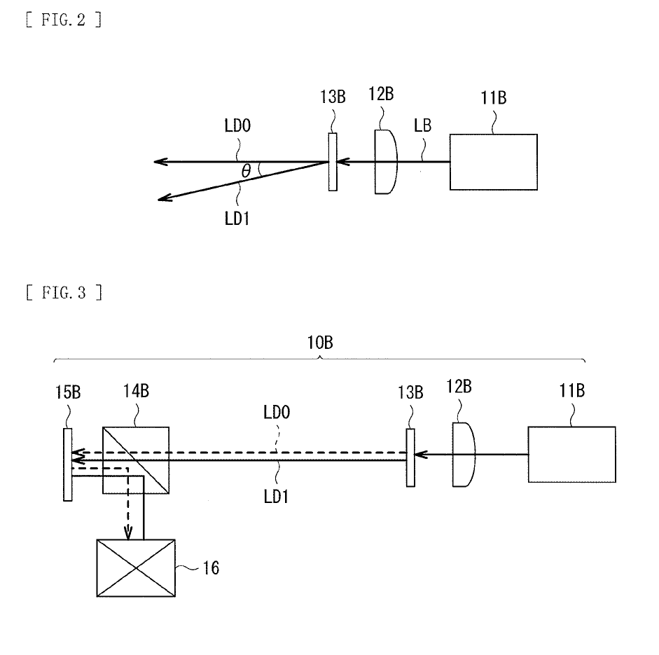

FIG. 2 schematically illustrates a state of the blue light L_{B} passing through the blue diffraction device 13B. When the blue light L_{B} enters the blue diffraction device 13B, zero-order light L_{D0} that travels in a transmissive direction as it is, and a first-order diffracted light L_{D1} that forms a diffractive angle θ with the zero-order light L_{D0} are generated. The same is true for the red diffraction device 13R and the green diffraction device 13G. In addition to the zero-order light L_{D0} and the first-order diffracted light L_{D1}, higher-order diffracted light, negative diffracted light, etc. are also generated; however, descriptions thereof are omitted here.

As will hereinafter be described in detail, in the red diffraction device 13R, the green diffraction device 13G, and the blue diffraction device 13B, a portion or a whole of light to be irradiated on a low-luminance pixel region is distributed onto a high-luminance pixel region. This makes it possible to suppress deterioration in the optical utilization efficiency while achieving an HDR (High Dynamic Range).

The red polarization split device 14R, the green polarization split device 14G, and the blue polarization split device 14B include, for example, polarizing beam splitters or wire grid polarizers. The red polarization split device 14R guides the zero-order light and the first-order diffracted light from the red diffraction device 13R toward the red spatial light modulation device 15R, and further guides the post-modulation red light toward the color synthesizing device 16. Similarly, the green polarization split device 14G guides the zero-order light and the first-order diffracted light from the green diffraction device 13G toward the green spatial light modulation device 15G, and further guides the post-modulation green light toward the color synthesizing device 16. The blue polarization split device 14B guides the zero-order light and the first-order diffracted light from the blue diffraction device 13B toward the blue spatial light modulation device 15B, and further guides the post-modulation blue light toward the color synthesizing device 16.

The red spatial light modulation device 15R, the green spatial light modulation device 15G, and the blue spatial light modulation device 15B include, for example, liquid crystal panels, or DMDs (Digital Micro-mirror Devices), etc. The red spatial light modulation device 15R, the green spatial light modulation device 15G, and the blue spatial light modulation device 15B are, for example, reflective spatial light modulation devices, in which light incoming from a front surface side is intensity-modulated to be extracted from the front surface side. In the red spatial light modulation device 15R, the green spatial light modulation device 15G, and the blue spatial light modulation device 15B, incoming red light, green light, and blue light are respectively intensity-modulated depending on the incoming image signal (the image signal S_{V} in FIG. 4 to be described later), thereby forming desired patterns (images). Such respective patterns are guided to the color synthesizing device 16 by the red polarization split device 14R, the green polarization split device 14G, and the blue polarization split device 14B.

In the present embodiment, at least a portion of the zero-order light L_{D0}, and the first-order diffracted light L_{D1} of the blue diffraction device 13B enter the blue spatial light modulation device 15B, as illustrated in FIG. 3. Similarly, at least a portion of the zero-order light, and the first-order diffracted light of the red diffraction device 13R enter the red spatial light modulation device 15R, and at least a portion of the zero-order light, and the first-order diffracted light of the green diffraction device 13G enter the green spatial light modulation device 15G. As will hereinafter be described in detail, this makes it possible to improve the diffractive efficiency of the first-order diffracted light, which allows the optical utilization efficiency to be enhanced. As an alternative, the whole zero-order light, and the first-order diffracted light may enter the red spatial light modulation device 15R, the green spatial light modulation device 15G, and the blue spatial light modulation device 15B.

The red spatial light modulation device 15R, the green spatial light modulation device 15G, and the blue spatial light modulation device 15B are disposed on optical axes of the red light L_{R} from the red light source 11R, the green light L_{G} from the green light source 11G, and the blue light L_{B} from the blue light source 11B, respectively. Here, the optical axes denote light beams proceeding in a direction identical to a traveling direction of the zero-order light of the red diffraction device 13R, the green diffraction device 13G, and the blue diffraction device 13B. The red spatial light modulation device 15R, the green spatial light modulation device 15G, and the blue spatial light modulation device 15B may be substantially disposed on the optical axes of the red light L_{R}, the green light L_{G}, and the blue light L_{B} respectively, and any deviations such as manufacturing errors are permissible as a tolerance. The red spatial light modulation device 15R, the green spatial light modulation device 15G, and the blue spatial light modulation device 15B are disposed to face the red diffraction device 13R, the green diffraction device 13G, and the blue diffraction device 13B of, for example, transmissive types, respectively.

The color synthesizing device 16 is a device that synthesizes (color-synthesizes) red light, green light, and blue light that are guided respectively from the red polarization split device 14R, the green polarization split device 14G, and the blue polarization split device 14B (the red optical section 10R, the green optical section 10G, and the blue optical section 10B) to guide the synthesized color light to the projection optical system 17. The color synthesizing device 16 includes a cross-dichroic prism, for example.

The projection optical system 17 is an optical system that projects light synthesized by the color synthesizing device 16 on a screen 110 to form an image, and is configured to include a lens group, for example.

The control section 20 has, for example, a high-luminance region extraction circuit 21, a diffraction pattern computational circuit 22, a diffraction device drive circuit 23, a display pattern computational circuit 24, a spatial light modulation device drive circuit 25, and a timing control circuit 26, as illustrated in FIG. 4. The high-luminance region extraction circuit 21, the diffraction pattern computational circuit 22, and the diffraction device drive circuit 23 generate signals to drive the red diffraction device 13R, the green diffraction device 13G, and the blue diffraction device 13B. The display pattern computational circuit 24 and the spatial light modulation device drive circuit 25 generate signals to drive the red spatial light modulation device 15R, the green spatial light modulation device 15G, and the blue spatial light modulation device 15B.

The high-luminance region extraction circuit 21 extracts information concerning a high-luminance region (high-luminance region information I) from the image signal S_{V} to be transmitted from the external image signal output apparatus 120. Along with the diffraction pattern computational circuit 22, the high-luminance region extraction circuit 21 transmits the high-luminance region information I to the display pattern computational circuit 24.

The diffraction pattern computational circuit 22 generates signals to form desired diffraction patterns in the red diffraction device 13R, the green diffraction device 13G, and the blue diffraction device 13B depending on the high-luminance region information I. The diffraction pattern computational circuit 22 generates a signal to be transmitted to the diffraction device drive circuit 23 by executing repeated computation of inverse Fourier transform (IFT: Inverse Fourier Transform) and Fourier transform, for example.

The diffraction device drive circuit 23 drives the red diffraction device 13R, the green diffraction device 13G, and the blue diffraction device 13B on the basis of the signal generated by the diffraction pattern computational circuit 22. This causes the red diffraction device 13R, the green diffraction device 13G, and the blue diffraction device 13B to generate diffracted light. The red spatial light modulation device 15R, the green spatial light modulation device 15G, and the blue spatial light modulation device 15B are irradiated with such diffracted light serving as illuminating light having the predetermined intensity distribution.

The display pattern computational circuit 24 generates signals to drive the red spatial light modulation device 15R, the green spatial light modulation device 15G, and the blue spatial light modulation device 15B on the basis of the image signal S_{V} and the high-luminance region information I to be transmitted from the high-luminance region extraction circuit 21. The spatial light modulation device drive circuit 25 drives the red spatial light modulation device 15R, the green spatial light modulation device 15G, and the blue spatial light modulation device 15B depending on the signals from the display pattern computational circuit 24.

The timing control circuit 26 controls drive timing in such a manner that the red diffraction device 13R, the green diffraction device 13G, and the blue diffraction device 13B, as well as the red spatial light modulation device 15R, the green spatial light modulation device 15G, and the blue spatial light modulation device 15B are driven in synchronization with one another. For example, the timing control circuit 26 transmits timing signals to the diffraction device drive circuit 23 and the spatial light modulation device drive circuit 25.

### (Operation)

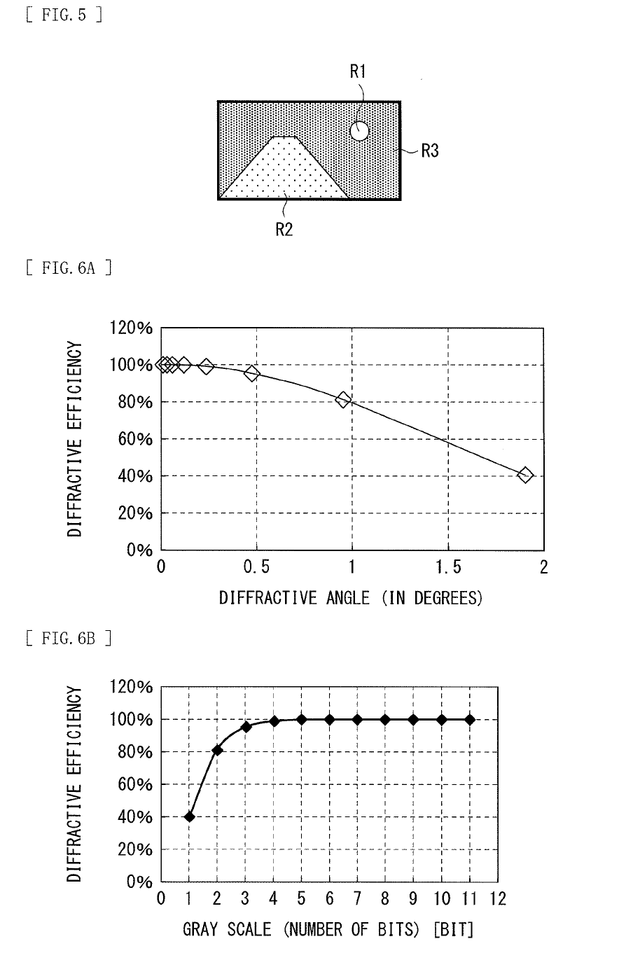

Hereinafter, the description is provided on operation of the projection display unit 1 of the present embodiment. The description is provided by citing an example where an image illustrated in FIG. 5 is inputted as the image signal S_{V} from the outside. FIG. 5 includes a region 1R1 of a moon portion, a region 2R2 of a mountain portion, and a region 3R3 of a background portion. The image has, for example, luminance levels of 1000, 50, and 0 in the regions 1R1, 2R2, and 3R3, respectively. In other words, a ratio of the luminance level of the region 1R1 to the region 2R2 is 20:1.

When the red light source 11R, the green light source 11G, and the blue light source 11B are driven, the red light L_{R}, the green light L_{G}, and the blue light L_{B} that are emitted respectively from those light sources pass through the red shaping optical system 12R, the green shaping optical system 12G, and the blue shaping optical system 12B in the first place. This ensures that beam forms are converted, and polarizing directions are aligned, and thereafter the resulting light enters the red diffraction device 13R, the green diffraction device 13G, and the blue diffraction device 13B.

The high-luminance region extraction circuit 21 extracts, for example, the region 1R1 and the region 2R2 from the image signal S_{V} to transmit this information to the diffraction pattern computational circuit 22 and the display pattern computational circuit 24 as the high-luminance region information I. The high-luminance region information I includes, for example, information indicating that the red spatial light modulation device 15R, the green spatial light modulation device 15G, and the blue spatial light modulation device 15B are irradiated with patterns ensuring that the luminance of both of the region 1R1 and the region 2R2 becomes 1000 cd/m³ from the red diffraction device 13R, the green diffraction device 13G, and the blue diffraction device 13B. The diffraction pattern computational circuit 22 generates a signal on the basis of the high-luminance region information I to transmit a resulting signal to the diffraction device drive circuit 23. This drives the red diffraction device 1311 the green diffraction device 13G, and the blue diffraction device 13B.

The zero-order light and the first-order diffracted light from the red diffraction device 13R, the green diffraction device 13G, and the blue diffraction device 13B pass through the red polarization split device 14R, the green polarization split device 14G, and the blue polarization split device 14B to enter the red spatial light modulation device 15R, the green spatial light modulation device 15G, and the blue spatial light modulation device 15B, respectively. As a result, the red spatial light modulation device 15R, the green spatial light modulation device 15G, and the blue spatial light modulation device 15B are irradiated with patterns in accordance with the high-luminance region information I, that is, the patterns ensuring that the luminance of both of the region 1R1 and the region 2R2 becomes 1000 cd/m³ as illuminating light.

Meanwhile, considering that the red spatial light modulation device 15R, the green spatial light modulation device 15G, and the blue spatial light modulation device 15B are irradiated with the patterns in accordance with the above-described high-luminance region information I, the display pattern computational circuit 24 generates a signal to be transmitted to the spatial light modulation device drive circuit 25. For example, the display pattern computational circuit 24 generates the signal in such a manner that an image having luminance levels of 200, 10, and 0 in the region 1R1, the region 2R2, and the region 3R3 respectively is formed in each of the red spatial light modulation device 15R, the green spatial light modulation device 15G, and the blue spatial light modulation device 15B.

This signal is transmitted to the spatial light modulation device drive circuit 25 to drive the red spatial light modulation device 15R, the green spatial light modulation device 15G, and the blue spatial light modulation device 15B. The red spatial light modulation device 15R, the green spatial light modulation device 15G, and the blue spatial light modulation device 15B modulate the illuminating light from the red diffraction device 13R, the green diffraction device 13G, and the blue diffraction device 13B, respectively. This forms an image in which a ratio of the luminance level of the region 1R1 to the region 2R2 is 20:1, that is, an image in accordance with the image signal S_{V}. The post-modulation red light, green light, and blue light enter the color synthesizing device 16 to be synthesized by the color synthesizing device 16. Such synthesized light is projected on the screen 110 by the projection optical system 17 to be displayed.

### (Workings and Effects)

In the projection display unit 1 of the present embodiment, at least a portion of the zero-order light, and the first-order diffracted light of the red diffraction device 13R enter the red spatial light modulation device 15R. Similarly, at least a portion of the zero-order light, and the first-order diffracted light of the green diffraction device 13G enter the green spatial light modulation device 15G, and at least a portion of the zero-order light, and the first-order diffracted light of the blue diffraction device 13B enter the blue spatial light modulation device 15B. This makes it possible to improve the diffractive efficiency of the first-order diffracted light of the red diffraction device 13R, the green diffraction device 13G, and the blue diffraction device 13B, which allows the optical utilization efficiency to be enhanced. This is described below.

Any pattern is not formed in zero-order light of a diffraction device, and therefore the zero-order light is typically recognized to be unwanted light. Such zero-order light is split from first-order diffracted light, and only the first-order diffracted light is utilized. An example of a method of splitting the first-order diffracted light and the zero-order light from each other includes a method of increasing a diffractive angle (for example, the diffractive angle θ in FIG. 2).

FIG. 6A is a graph representing a relationship between a diffractive angle of a diffraction device (a pixel pitch of 8 μm) and diffractive efficiency. In the graph, a vertical scale denotes the diffractive efficiency (in %) of the first-order diffracted light, and a horizontal scale denotes the diffractive angle (in degrees). As seen from the graph, an increase in the diffractive angle results in a decrease in the diffractive efficiency. Thus, in case of an increase in the diffractive angle, the optical utilization efficiency of an optical system including a diffraction device would deteriorate in association with a decrease in the diffractive efficiency. To split the first-order diffracted light and the zero-order light from each other with the diffractive angle reduced (while keeping the diffractive efficiency), it is necessary to take a longer optical path. This makes it difficult to achieve size reduction of an apparatus.

In contrast, in the projection display unit 1, at least a portion of the zero-order light, and the first-order diffracted light of the red diffraction device 13R (or the green diffraction device 13G and the blue diffraction device 13B) enter the red spatial light modulation device 15R (or the green spatial light modulation device 15G and the blue spatial light modulation device 15B). In other words, the zero-order light and the first-order diffracted light of the red diffraction device 13R are not split from each other, which makes it possible to provide the red diffraction device 13R having the high diffractive efficiency regardless of the diffractive angle.

In a diffraction device including a liquid crystal panel, for example, the diffractive efficiency varies with a gray scale of the diffraction device, as illustrated in FIG. 6B. For example, the use of the diffraction device (a liquid crystal panel) having the gray scale of six bits or more allows the high diffractive efficiency to be achieved. In addition to this, the diffractive efficiency of the diffraction device will vary depending on a variety of conditions.

Further, the zero-order light and the first-order diffracted light of the red diffraction device 13R are not split from each other, which eliminates the need for a longer optical path, allowing for size reduction of an apparatus as well.

Additionally, the zero-order light of the red diffraction device 13R has no functionality serving as diffracted light: however, it is usable as illuminating light.

As described above, in the present embodiment, at least a portion of the zero-order light, and the first-order diffracted light each of the red diffraction device 13R, the green diffraction device 13G, and the blue diffraction device 13B enter the red spatial light modulation device 15R. In other words, it is unnecessary to split the zero-order light and the first-order diffracted light each of the red diffraction device 13R, the green diffraction device 13G, and the blue diffraction device 13B, which makes it possible to use the red diffraction device 13R, the green diffraction device 13G, and the blue diffraction device 13B that achieve the high diffractive efficiency without considering the diffractive angle. This makes it possible to improve the diffractive efficiency of the red diffraction device 13R, the green diffraction device 13G, and the blue diffraction device 13B, allowing the optical utilization efficiency to be enhanced. Moreover, the zero-order light is usable as the illuminating light, which allows the optical utilization efficiency to be further enhanced. In addition, a longer optical path is unnecessary, which allows for size reduction of an apparatus.

Further, in the projection display unit 1, the red diffraction device 13R, the green diffraction device 13G, and the blue diffraction device 13B, as well as the red spatial light modulation device 15R, the green spatial light modulation device 15G, and the blue spatial light modulation device 15B are combined with one another, which allows deterioration in the optical utilization efficiency to be suppressed while achieving the HDR. This is also described below.

As a method of achieving the HDR, it is considered to combine a plurality of spatial light modulation devices that perform intensity modulation. However, the spatial light modulation device that performs the intensity modulation blocks light for the intensity modulation, resulting in deterioration in the optical utilization efficiency. Specifically, in a case where an image of a dark screen in whole is to be displayed, the optical utilization efficiency will deteriorate significantly. Further, in some cases, light often leaks in a region where the light is originally to be blocked, and therefore the contrast is likely to degrade.

In contrast, in the red diffraction device 13R, the green diffraction device 13G, and the blue diffraction device 13B, light to be applied onto a low-luminance pixel region is distributed onto a high-luminance pixel region, which allows deterioration in the optical utilization efficiency to be suppressed, as compared with a case where the spatial light modulation device that performs the intensity modulation is provided. Therefore, it is possible to suppress deterioration in the optical utilization efficiency while achieving the HDR. Further, this also allows deterioration in the contrast to be suppressed.

Hereinafter, the description is provided on modification examples of the above-described embodiment. Any component parts common to those in the above-described embodiment are denoted with the same reference numerals, and the related descriptions are omitted as appropriate.

### Modification Example 1

FIG. 7 schematically illustrates a configuration of a blue optical section 10B of a projection display unit (a projection display unit 1A) according to a modification example 1. In the blue optical section 10B, a lens (a lens 18) is provided at an optical path between a blue diffraction device 13B and a blue spatial light modulation device 15B, more specifically, at an optical path between the blue diffraction device 13B and a blue polarization split device 14B. Although not illustrated, in the projection display unit 1A, lenses are also provided at an optical path between a red diffraction device 13R and a red spatial light modulation device 15R, and at an optical path between a green diffraction device 13G and a green spatial light modulation device 15G. In such a point, the projection display unit 1A is different from the projection display unit 1 of the above-described embodiment.

The lens 18 includes a convex lens or a concave lens. The lens 18 serves to magnify a region in which the blue spatial light modulation device 15B is irradiated with zero-order light of the blue diffraction device 13B.

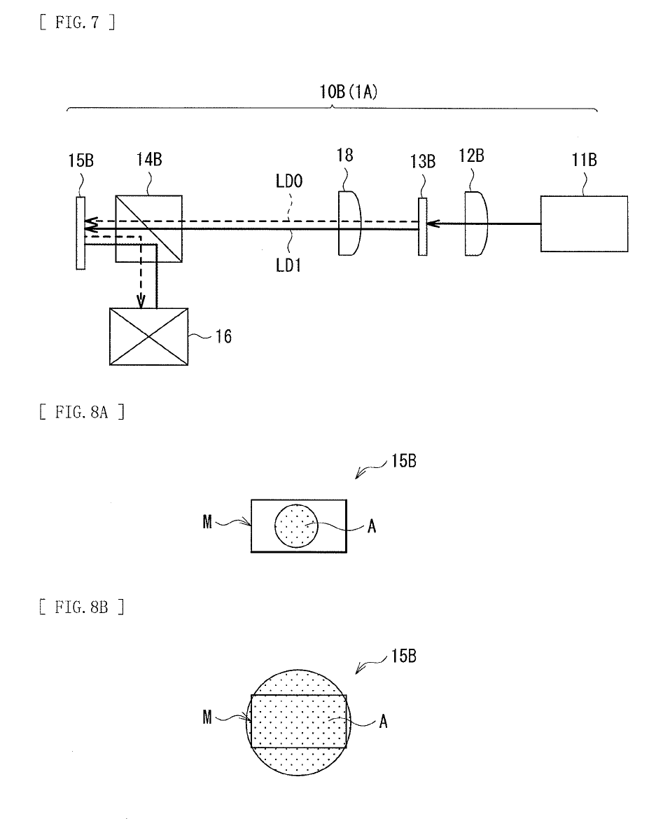

Each of FIG. 8A and FIG. 8B schematically illustrates a region (a zero-order light irradiation region A) in which an opening (an opening M) of the blue spatial light modulation device 15B is irradiated with the zero-order light of the blue diffraction device 13B. FIG. 8A illustrates the zero-order light irradiation region A in a case where the lens 18 is not provided, and FIG. 8B illustrates the zero-order light irradiation region A in a case where the lens 18 is provided. Adjustment of a focal length and a position of the lens 18 allows the zero-order light of the blue diffraction device 13B to be diverged greatly. This allows the zero-order light irradiation region A to be made larger than the opening M of the blue spatial light modulation device 15B, thereby irradiating a whole surface of the opening M with the zero-order light. This makes it possible to reduce unevenness in illuminating light from the blue diffraction device 13B. Adjustment of the focal length of the lens 18 allows a pattern of first-order diffracted light to be formed on the blue spatial light modulation device 15B while diverging the zero-order light of the blue diffraction device 13B. Preferably, the blue spatial light modulation device 15B is disposed to avoid a Fourier surface of the lens 18. In a case where the blue spatial light modulation device 15B is disposed on the Fourier surface of the lens 18, the zero-order light is formed as a bright point on the blue spatial light modulation device 15B, possibly causing deterioration in the image quality.

As with the above-described projection display unit 1, the projection display unit 1A makes it possible to improve the diffractive efficiency of the blue diffraction device 13B (or the red diffraction device 13R, or the green diffraction device 13G), thereby allowing for enhancement of the optical utilization efficiency. Further, the lens 18 is provided at the optical path between the blue diffraction device 13B (or the red diffraction device 13R, or the green diffraction device 13G) and the blue spatial light modulation device 15B (or the red spatial light modulation device 15R, or the green spatial light modulation device 15G), which makes it possible to diverge the zero-order light of the blue diffraction device 13B, thereby allowing for reduction in the irradiation unevenness of the illuminating light from the blue diffraction device 13B.

### Modification Example 2

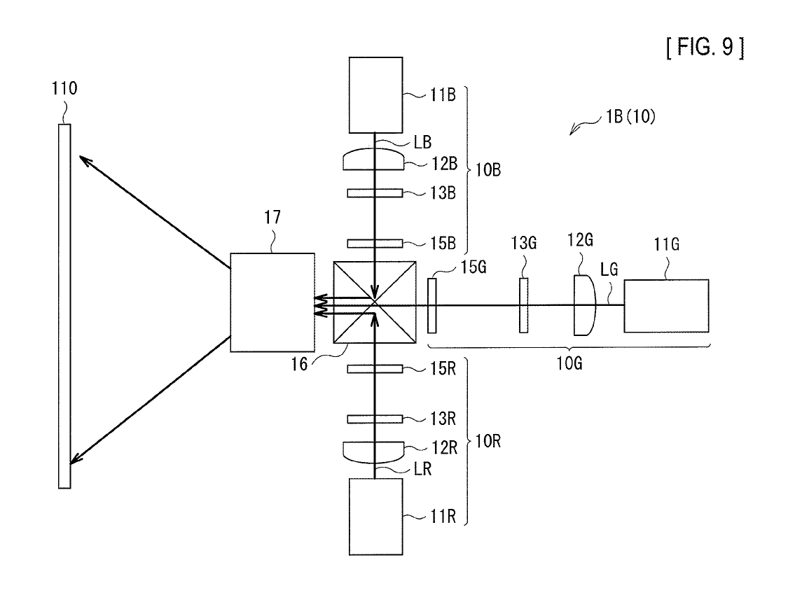

FIG. 9 schematically illustrates a configuration of an optical section 10 of a projection display unit (a projection display unit 1B) according to a modification example 2. The projection display unit 1B has a red spatial light modulation device 15R, a green spatial light modulation device 15G, and a blue spatial light modulation device 15B of transmissive types. In such a point, the projection display unit 1B is different from the projection display unit 1 of the above-described embodiment.

In the red spatial light modulation device 15R, the green spatial light modulation device 15G, and the blue spatial light modulation device 15B of the transmissive types, for example, light incoming from a rear surface side is intensity-modulated to be extracted from a front surface side.

As with the above-described projection display unit 1, such a projection display unit 1B also makes it possible to improve the diffractive efficiency of the red diffraction device 13R, the green diffraction device 13G, and the blue diffraction device 13B, thereby allowing for enhancement of the optical utilization efficiency.

### Modification Example 3

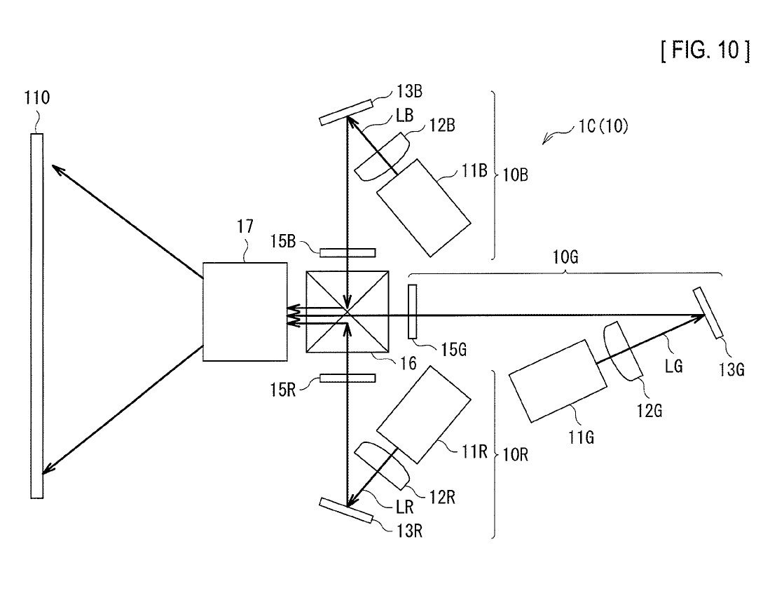

FIG. 10 schematically illustrates a configuration of an optical section 10 of a projection display unit (a projection display unit 1C) according to a modification example 3. The projection display unit 1C has a red diffraction device 13R, a green diffraction device 13G, and a blue diffraction device 13B of reflective types, as well as a red spatial light modulation device 15R, a green spatial light modulation device 15G, and a blue spatial light modulation device 15B of transmissive types. In such a point, the projection display unit 1C is different from the projection display unit 1 of the above-described embodiment.

In the red diffraction device 13R, the green diffraction device 13G, and the blue diffraction device 13B of the reflective types, for example, diffracted light of light (red light L_{R}, green light L_{G}, and blue light L_{B}) incoming from a front surface side is extracted from the front surface side. The red spatial light modulation device 15R, the green spatial light modulation device 15G, and the blue spatial light modulation device 15B are disposed at optical paths of the red light L_{R}, the green light L_{G}, and the blue light L_{B}, respectively. Specifically, the red spatial light modulation device 15R, the green spatial light modulation device 15G, and the blue spatial light modulation device 15B are disposed in a direction of zero-order light of the red diffraction device 13R, the green diffraction device 13G, and the blue diffraction device 13B of the reflective types, that is, in a direction of reflected light.

As with the above-described projection display unit 1, such a projection display unit 1C also makes it possible to improve the diffractive efficiency of the red diffraction device 13R, the green diffraction device 13G, and the blue diffraction device 13B, thereby allowing for enhancement of the optical utilization efficiency.

### Modification Example 4

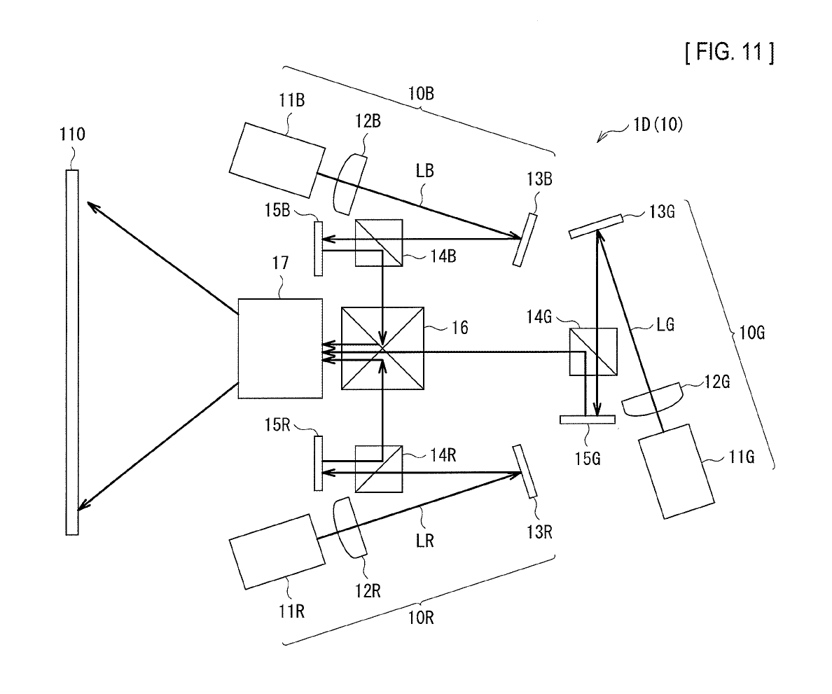

FIG. 11 schematically illustrates a configuration of an optical section 10 of a projection display unit (a projection display unit 1D) according to a modification example 4. The projection display unit 1D has a red diffraction device 13R, a green diffraction device 13G, and a blue diffraction device 13B of reflective types. In such a point, the projection display unit 1D is different from the projection display unit 1 of the above-described embodiment. A red spatial light modulation device 15R, a green spatial light modulation device 15G, and a blue spatial light modulation device 15B are of the reflective types, for example.

As with the above-described projection display unit 1, such a projection display unit 1D also makes it possible to improve the diffractive efficiency of the red diffraction device 13R, the green diffraction device 13G, and the blue diffraction device 13B, thereby allowing for enhancement of the optical utilization efficiency.

### Modification Example 5

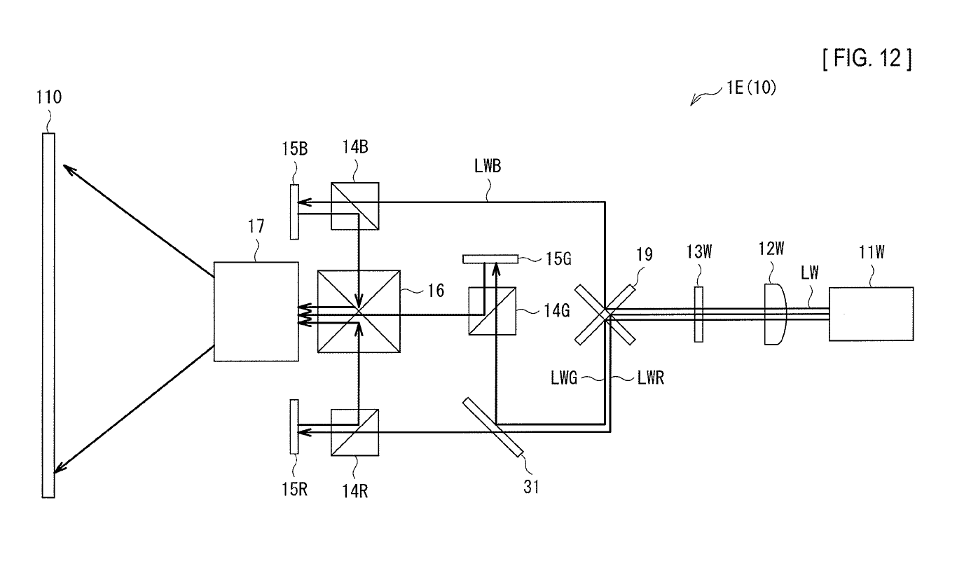

FIG. 12 schematically illustrates a configuration of an optical section 10 of a projection display unit (a projection display unit 1E) according to a modification example 5. The projection display unit 1E has a white light source 11W that emits white light in place of the red light source 11R, the green light source 11G, and the blue light source 11B, and white light L_{W} emitted from the white light source 11W passes through a white shaping optical system 12W and a white diffraction device 13W in this order. In such a point, the projection display unit 1E is different from the projection display unit 1 of the above-described embodiment.

In the projection display unit 1E, at least a portion of zero-order light, and first-order diffracted light of the white diffraction device 13W are color-split into red light L_{WR}, green light L_{WG}, and blue light L_{WB}, which enter a red spatial light modulation device 15R, a green spatial light modulation device 15G, and a blue spatial light modulation device 15B, respectively. Specifically, in the first place, at least a portion of the zero-order light, and the first-order diffracted light of the white diffraction device 13W enter a color split device 19. The color split device 19 splits the incoming light into a combination of the red light L_{WR} and the green light L_{WG}, and the blue light L_{WB}, while guiding the combination of the red light L_{WR} and the green light L_{WG} to a color split device 31, and guiding the blue light L_{WB} to a blue polarization split device 14B. The combination of the red light L_{WR} and the green light L_{WG} are split into the red light L_{WR} and the green light L_{WG} by the color split device 31. The red light L_{WR} is guided to a red polarization split device 14R, and the green light L_{WG} is guided to a green polarization split device 14G. The blue light L_{WB} enters the blue spatial light modulation device 15B from the blue polarization split device 14B to be modulated, and thereafter enters a color synthesizing device 16 through the blue polarization split device 14B. The red light L_{WR} enters the red spatial light modulation device 15R from the red polarization split device 14R to be modulated, and thereafter enters the color synthesizing device 16 through the red polarization split device 14R. The green light L_{WG} enters the green spatial light modulation device 15G from the green polarization split device 14G to be modulated, and thereafter enters the color synthesizing device 16 through the green polarization split device 14G. The red light, the green light, and the blue light that are synthesized by the color synthesizing device 16 are projected on a screen 110 through a projection optical system 17. The color split devices 19 and 31 include dichroic mirrors, for example.

As with the above-described projection display unit 1, such a projection display unit 1E also makes it possible to improve the diffractive efficiency of the white diffraction device 13W, thereby allowing for enhancement of the optical utilization efficiency because at least a portion of the zero-order light, and the first-order diffracted light of the white diffraction device 13W are color-split, and thereafter enter the red spatial light modulation device 15R, the green spatial light modulation device 15G, and the blue spatial light modulation device 15B.

The technology is described thus far with reference to the embodiment and modification examples thereof; however, the technology is not limited to the above-described embodiment, etc., but various modifications may be made. For example, the component parts, the arrangements, the number, etc. of the optical sections exemplified in the above-described embodiment are merely illustrated, and it is unnecessary to provide all of the component parts, or any other component parts may be further provided.

For example, in the above-described embodiment, etc., the description is provided on an example where at least a portion of zero-order light, and first-order diffracted light of a diffraction device enter a spatial light modulation device in all of the red optical section 10R, the green optical section 10G, and the blue optical section 10B. However, at least a portion of the zero-order light, and the first-order diffracted light of the diffraction device may enter the spatial light modulation device in at least one of the red optical section 10R, the green optical section 10G, and the blue optical section 10B.

It is to be noted that the effects mentioned herein are merely exemplified. The effects of the technology are not limited to the effects described herein, and may have any effects other than those described herein.

Further, the technology may be configured as follows.

(1) A projection display unit including:

a light source;

a diffraction device that light from the light source enters;

a spatial light modulation device that at least a portion of zero-order light, and first-order diffracted light of the diffraction device enter; and

a projection optical system that light passing through the spatial light modulation device enters.

(2) The projection display unit according to (1), in which the diffraction device is of a transmissive type.
(3) The projection display unit according to (2), in which the spatial light modulation device is provided to face the diffraction device.
(4) The projection display unit according to (1), in which the diffraction device is of a reflective type.
(5) The projection display unit according to any one of (1) to (4), in which the spatial light modulation device is of a transmissive type.
(6) The projection display unit according to any one of (1) to (4), in which the spatial light modulation device is of a reflective type.
(7) The projection display unit according to any one of (1) to (6), further including a lens at an optical path between the diffraction device and the spatial light modulation device.
(8) The projection display unit according to (7), in which the lens magnifies an irradiation region of the zero-order light at a position of the spatial light modulation device.
(9) The projection display unit according to (7) or (8), in which a whole surface of an opening of the spatial light modulation device is irradiated with the zero-order light.
(10) The projection display unit according to any one of (1) to (9), in which the spatial light modulation device is provided on an optical axis of light from the light source.
(11) The projection display unit according to any one of (1) to (10), in which

the light source includes a red light source, a green light source, and a blue light source;

the diffraction device includes a red diffraction device that red light from the red light source enters, a green diffraction device that green light from the green light source enters, and a blue diffraction device that blue light from the blue light source enters; and

the spatial light modulation device includes a red spatial light modulation device that at least a portion of zero-order light, and first-order diffracted light of the red diffraction device enter, a green spatial light modulation device that at least a portion of zero-order light, and first-order diffracted light of the green diffraction device enter, and a blue spatial light modulation device that at least a portion of zero-order light, and first-order diffracted light of the blue diffraction device enter.

(12) The projection display unit according to any one of (1) to (11), further including:

a high-luminance region extraction circuit that extracts information concerning a high-luminance region from an incoming image signal;

a diffractive pattern computational circuit that generates a signal serving to drive the diffraction device on a basis of high-luminance region information from the high-luminance region extraction circuit; and

a display pattern computational circuit that generates a signal serving to drive the spatial light modulation device on a basis of the high-luminance region information from the high-luminance region extraction circuit and the image signal.

(13) The projection display unit according to any one of (1) to (10), in which the light source is a white light source, and light from the white light source enters the diffraction device.
(14) The projection display unit according to any one of (1) to (13), in which the light source includes a semiconductor laser (LD).

This application claims the priority on the basis of Japanese Patent Application No. 2016-146560 filed on Jul. 26, 2016 with Japan Patent Office, the entire contents of which are incorporated in this application by reference.

Those skilled in the art could assume various modifications, combinations, subcombinations, and changes in accordance with design requirements and other contributing factors. However, it is understood that they are included within a scope of the attached claims or the equivalents thereof.

What is claimed is:

1. A projection display unit comprising:
a light source;
a diffraction device that light from the light source enters;
a spatial light modulation device that at least a portion of zero-order light, and first-order diffracted light of the diffraction device enter; and
a projection optical system that light passing through the spatial light modulation device enters.

2. The projection display unit according to claim 1, wherein the diffraction device is of a transmissive type.

3. The projection display unit according to claim 2, wherein the spatial light modulation device is provided to face the diffraction device.

4. The projection display unit according to claim 1, wherein the diffraction device is of a reflective type.

5. The projection display unit according to claim 1, wherein the spatial light modulation device is of a transmissive type.

6. The projection display unit according to claim 1, wherein the spatial light modulation device is of a reflective type.

7. The projection display unit according to claim 1, further comprising a lens at an optical path between the diffraction device and the spatial light modulation device.

8. The projection display unit according to claim 7, wherein the lens magnifies an irradiation region of the zero-order light at a position of the spatial light modulation device.

9. The projection display unit according to claim 8, wherein a whole surface of an opening of the spatial light modulation device is irradiated with the zero-order light.

10. The projection display unit according to claim 1, wherein the spatial light modulation device is provided on an optical axis of light from the light source.

11. The projection display unit according to claim 1, wherein
the light source includes a red light source, a green light source, and a blue light source;
the diffraction device includes a red diffraction device that red light from the red light source enters, a green diffraction device that green light from the green light source enters, and a blue diffraction device that blue light from the blue light source enters; and
the spatial light modulation device includes a red spatial light modulation device that at least a portion of zero-order light, and first-order diffracted light of the red diffraction device enter, a green spatial light modulation device that at least a portion of zero-order light, and first-order diffracted light of the green diffraction device enter, and a blue spatial light modulation device that at least a portion of zero-order light, and first-order diffracted light of the blue diffraction device enter.

12. The projection display unit according to claim 1, further comprising:
a high-luminance region extraction circuit that extracts information concerning a high-luminance region from an incoming image signal;
a diffractive pattern computational circuit that generates a signal serving to drive the diffraction device on a basis of high-luminance region information from the high-luminance region extraction circuit; and
a display pattern computational circuit that generates a signal serving to drive the spatial light modulation device on a basis of the high-luminance region information from the high-luminance region extraction circuit and the image signal.

13. The projection display unit according to claim 1, wherein the light source is a white light source, and light from the white light source enters the diffraction device.

14. The projection display unit according to claim 1, wherein the light source includes a semiconductor laser (LD).
